(19) United States
(12) Patent Application Publication
(10) Pub. No.: US 2019/0187638 A1
(43) Pub. Date: Jun. 20, 2019

(54) CONFIGURING AN ELECTRONIC CONTROL BOARD FOR AN APPLIANCE

(71) Applicant: Haier US Appliance Solutions, Inc., Wilmington, DE (US)

(72) Inventors: Sukumar Arrojula, Louisville, KY (US); Charles Derek Hibdon, Loiusville, KY (US)

(21) Appl. No.: 15/841,437

(22) Filed: Dec. 14, 2017

(51) Int. Cl. G05B 15/02

(52) U.S. Cl. CPC G05B 15/02

(57) ABSTRACT

A method for configuring an electronic control board for a target appliance includes obtaining, by one or more processors, data identifying the target appliance. The method includes determining, by the one or more processors, hardware configuration data for the electronic control board based, at least in part, on the data identifying the target appliance. The method includes generating, by the one or more processors, a control action associated with writing the hardware configuration data to a memory device on the electronic board.

### FIELD

The present subject matter relates generally to appliances, and more particularly to systems and methods for configuring an electronic control board for an appliance.

### BACKGROUND

Manufacturing multiple models of an appliance (e.g., refrigerator, washing machine, etc.) necessitates maintaining an inventory of replacement parts for each model. However, since maintaining such an inventory is not cost-effective, replacement parts are made so that they be configured for use on any one of the different models. As an example, an electronic control board can be configurable so that the electronic control board can be used on multiple models of an appliance. However, conventional methods for configuring the electronic control board are generally undesirable. For instance, one method requires the replacement control board include additional hardware components, such as switches, jumpers, and harnesses. This is undesirable, because the additional hardware components increase the cost of manufacturing the replacement control board. In addition, the electronic control board must be manually configured by a technician. Accordingly, a needs exists for improved system and methods for configuring an electronic control board for an appliance.

### BRIEF DESCRIPTION

Aspects and advantages of embodiments of the present disclosure will be set forth in part in the following description, or may be learned from the description, or may be learned through practice of the embodiments.

In one example embodiment, a method for configuring an electronic control board for a target appliance includes obtaining, by one or more processors, data identifying the target appliance. The method includes determining, by the one or more processors, whether hardware configuration data exists for the electronic control board based, at least in part, on the data identifying the target appliance. When hardware configuration data exists for the target appliance, the method includes generating, by the one or more processors, a control action associated with writing the hardware configuration data to a memory device on the electronic board.

In another example embodiment, a system for configuring an electronic control board for a target appliance includes one or more processors and one or more memory devices. The one or more memory devices store computer-readable instructions that, when executed by the one or more processors, cause the one or more processors to perform operations. The operations include obtaining data identifying the target appliance. The operations further include determining whether hardware configuration data exists for the electronic control board based, at least in part, on the data identifying the target appliance. When hardware configuration data exists for the target appliance, the operations further include generating a control action associated with writing the hardware configuration data to a memory device on the electronic control board.

In yet another example embodiment, a method for configuring an electronic control board for a target appliance includes obtaining, by one or more processors, data identifying the target appliance. The method includes determining, by the one or more processors, whether hardware configuration data is stored in a memory device on the electronic control board. When no hardware configuration data is stored in the memory device, the method includes determining, by the one or more processors, whether hardware configuration data exists for the electronic control board. When hardware configuration data exists for the electronic control board, the method includes generating, by the one or more processors, a control action associated with writing the hardware configuration data to the memory device on the electronic control board.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 illustrates a block diagram of first and second appliances according to example embodiments of the present disclosure;

FIG. 2 illustrates a block diagram of a system for configuring an electronic control board for a target appliance according to example embodiments of the present disclosure;

FIG. 3 illustrates a block diagram of a configuration controller according to example embodiments of the present disclosure;

FIG. 4 illustrates flow diagram of a method for configuring an electronic control board for a target appliance according to example embodiments of the present disclosure; and

FIG. 5 illustrates a block diagram of a computing system according to example embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Example aspects of the present disclosure are directed to a method for configuring an electronic control board for a target appliance. The method includes obtaining, by one or more processors, data identifying the target appliance. For instance, the data identifying the target appliance can include, without limitation, an image of the target appliance, a model number assigned to the target appliance, and a serial number assigned to the target appliance.

The method also includes determining, by the one or more processors, whether hardware configuration data exists for the target appliance based, at least in part, on the data identifying target appliance. The hardware configuration data can be used to determine whether one or more features on the electronic control board are disabled or enabled.

The method further includes generating, by the one or more processors, a control action associated with writing the hardware configuration data to a memory device of the electronic control board. In this manner, a processor on the electronic control board can obtain the hardware configuration data and configure the electronic control board. More specifically, the processor can disable or enable one or more features of the electronic control board based, at least in part, on the hardware configuration data.

Another example aspect of the present disclosure is directed to a system for configuring an electronic control board for a target appliance. The system includes one or more processors and one or more memory devices. The one or more memory devices can be configured to store computer-readable instructions that, when executed by the one or more processors, cause the one or more processors to perform operations similar to the method discussed above.

Aspects of the present disclosure can provide a number of technical effects and benefits. For instance, determining hardware configuration data based, at least in part, on data identifying the target appliance reduces the amount of human involvement required to configure the electronic control board for the target appliance. Furthermore, since the amount of human involvement is reduced, the electronic control board can be configured for use with multiple models of appliances.

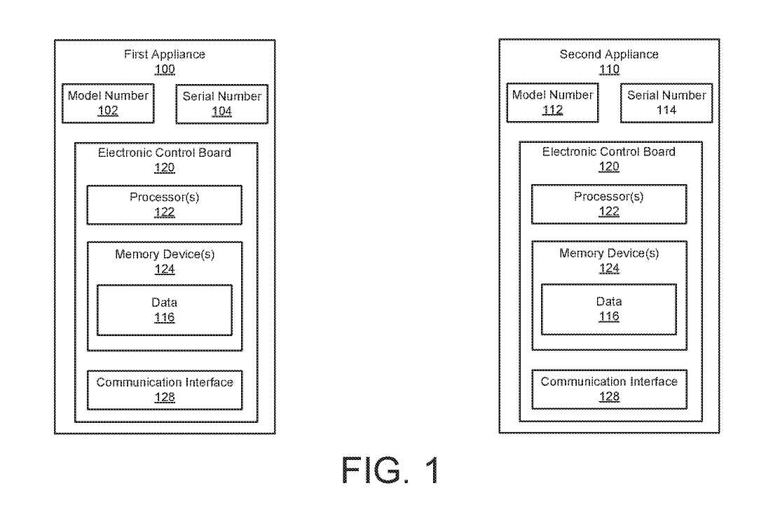

FIG. 1 depicts a block diagram view of a first appliance 100 and a second appliance 110. In some embodiments, the first appliance 100 can be different than the second appliance 110. For instance, the first appliance 100 can be a refrigerator appliance, whereas the second appliance 110 can be a washing machine appliance. In alternative embodiments, both the first and second appliances 100, 110 can be a refrigerator appliance. It should be appreciated, however, that the first and second appliances 100, 110 can be any suitable type of appliance. For instance, the first and second appliances 100, 110 can each be a dryer appliance. Alternatively, the first and second appliances 100, 110 can each be a washing machine appliance. Still further, the first and second appliances 100, 110 can each be an oven appliance.

As shown, the first and second appliances 100, 110 are each assigned a model number 102, 112 that identifies one of a plurality of models of an appliance. For example, the first and second appliances 100, 110 may both be a refrigerator appliance, but may be different models of the refrigerator appliance. More specifically, the first appliance 100 may correspond to model A of the refrigerator appliance, whereas the second appliance 110 may correspond to model B of the refrigerator appliance. As such, the model number 102 assigned to the first appliance 100 would be different than the model number 112 assigned to the second appliance 110. Alternatively, the first and second appliances 100, 110 may each correspond to model A of the appliance. In this instance, the model number 102 assigned to the first appliance 100 would match the model number 112 assigned to the second appliance 110.

The first and second appliances 100, 110 are also assigned a serial number 104, 114. The serial numbers 104, 114 indicate how many instances of an appliance have been produced. As such, the serial number 104 of the first appliance 100 cannot match the serial number 114 of the second appliance 110.

The first and second appliances 100, 110 can each include an electronic control board 120. As shown, the electronic control board 120 can include a processor 122 and associated memory device 124 configured to perform a variety of computer-implemented functions (e.g., performing the methods, steps, calculations and the like disclosed herein). In example embodiments, the memory device 124 can store data 126. In example embodiments, the data 126 can include the model number 102, 112 and the serial number 104, 114. Alternatively or additionally, the data 126 can include hardware configuration data that can be used to configure the electronic control board 120 to control operation of the first appliance 100 or the second appliance 110. For instance, hardware configuration data can include, without limitation, firmware that, when executed by the processor 122, configures the electronic control board 120 to control operation of the first appliance 100 or the second appliance 110.

The electronic control board 120 also includes a communications interface 128 that includes associated electronic circuitry used to send and receive data. As an example, the communications interface 128 can be used to send and receive data to and from another electronic control board. It should be appreciated that the communications interface 128 includes any combination of suitable wired and/or wireless communications interfaces and, thus, may be communicatively coupled to one or more components of the appliances 100, 110 via a wired and/or wireless connection.

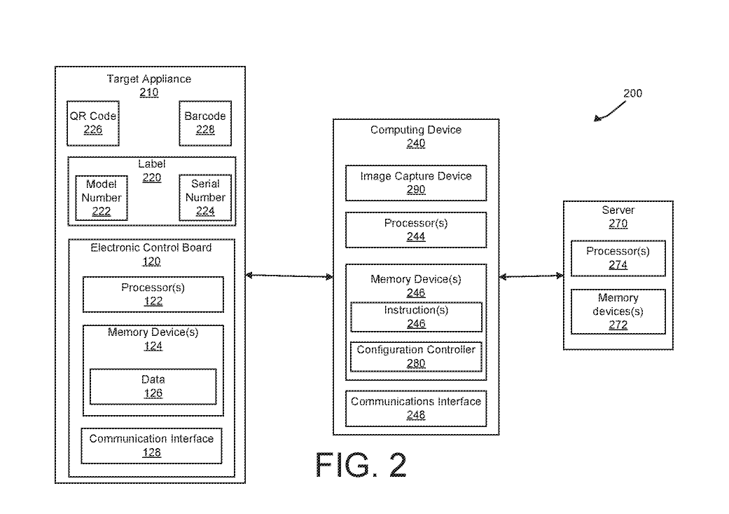

FIG. 2 depicts a system 200 for configuring the electronic control board 120 for a target appliance 210 according to example embodiments of the present disclosure. In example embodiments, the electronic control board 120 can be a replacement control board for another electronic control board already installed on the target appliance 210. As will be discussed below in more detail, data identifying the target appliance 210 can be used to configure the electronic control board 120.

In example embodiments, the target appliance 210 includes a label 220 that can include data identifying the target appliance 210. For example, the label 220 can include a model number 222 and a serial number 224. It should be appreciated that both the model number 222 and the serial number 224 can be assigned to the target appliance 210 by a manufacturer of the target appliance 210.

In example embodiments, the target appliance 210 can include at least one of a quick recognition (QR) code 226 and a bar code 228 configured to include data identifying the target appliance 210. For instance, the data can include the model number 222 assigned to the target appliance 210. Alternatively or additionally, the data can include the serial number 224 assigned to the target appliance 210.

In example embodiments, the memory device 124 on the electronic control board 120 can store data 126 identifying the target appliance 210, such as the model number 222 and the serial number 224 assigned to the target appliance 210. Alternatively, another electronic control board already installed on the target appliance 210 can store data identifying the target appliance 210. As will be discussed below in more detail, the system 200 can be configured to obtain data identifying the target appliance 210.

As shown, the system 200 includes a computing device 240 having at least one processor 242 configured to perform a variety of computer-implemented functions (e.g., performing the methods, steps, calculations and the like disclosed herein). In addition, the computing device 240 includes a memory device 244 configured to store information, including computer-readable instructions 246 that can be executed by the processor 242. The computer-readable instructions 246 can be any set of instructions that, when executed by the processor 242, cause the processor 242 to perform operations. The computer-readable instructions 246 can be software written in any suitable programming language or can be implemented in hardware.

Additionally, the computing device 240 can include a communications interface 248. In example embodiments, the communications interface 248 can include associated electronic circuitry that can be used to communicatively couple the computing device 240 with other devices, such as the electronic control board 120, a server 270, or any other suitable computing device. In some embodiments, the communication interface 248 can allow the computing device 240 to communicate directly with other devices (e.g., one or more electronic control boards on the target appliance 210). In alternative embodiments, the communication interface 248 can provide for communication with other devices over a wired or wireless network.

As shown, the memory device 244 includes a configuration controller 280. Although shown as a portion of code stored by the memory device 244, the configuration controller 280 may be implemented in any suitable technology according to the needs of a particular implementation. The configuration controller 280 may be implemented using hardware, software, or combinations of hardware or software. Suitable hardware may include, but is not limited to a processor, a field programmable gate-array, an application specific integrated circuit (ASIC), digital or analog electrical circuit, packaged hardware units, and the like. Suitable software may include, but is not limited to, a portion of program code that is executable by a processor to perform a particular function or set of functions, a self-contained software component, firmware, and the like. The configuration controller 280 may include software stored in a processor readable storage device to program a processor to perform the functions described herein. The configuration controller 280 may be implemented on the processor 242. Alternatively, the configuration controller 280 may be stored in a memory device 272 of the server 270 and implemented on one or more processors 274 thereof. In some embodiments, the computing device 240 and the server 270 can each perform various functions of the configuration controller 280. For example, the computing device 240 can be used to obtain data identifying the target appliance 210, and the server 270 can be used to determine hardware configuration data for the target appliance 210.

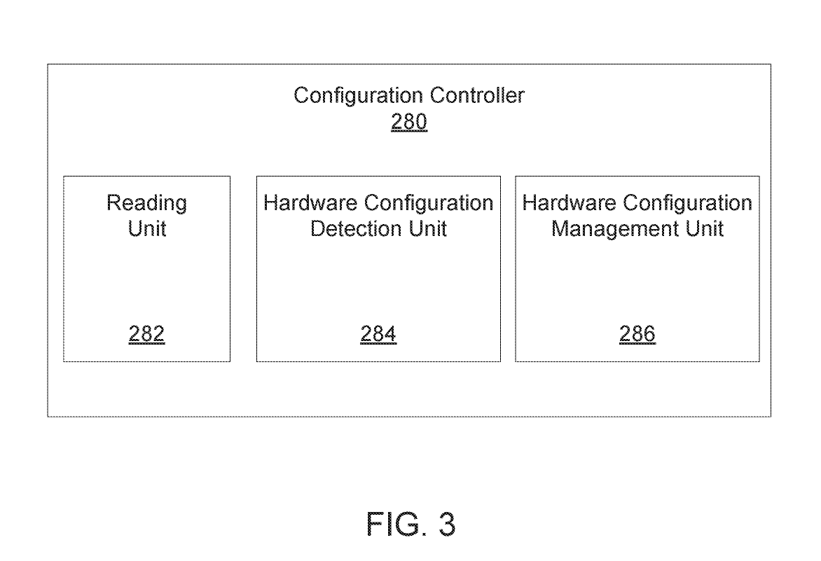

FIG. 3 depicts a configuration controller 280 according to example embodiments of the present disclosure. The configuration controller 280 may be used to obtain data identifying the target appliance 210 and determine hardware configuration data based, at least in part, on the data identifying the target appliance 210. The configuration controller 280 may be further configured to generate one or more control actions in response to determining hardware configuration data for the target appliance 210. In alternative embodiments, the configuration controller 280 may be configured to determine hardware configuration data already installed on the electronic control board 120 is incorrect hardware configuration data and generate one or more control actions associated with overwriting the incorrect hardware configuration data with correct hardware configuration data.

As shown, the configuration controller 280 can include a reading unit 282, a hardware configuration data detection unit 284, and hardware configuration data management unit 286. The individual units of the configuration controller 280 may be configured as described above with respect to configuration controller 280. Each unit may be implemented using software, hardware, or any combination of hardware and software. The individual units may be configured together in a single unit such as a single processing unit or may be configured in distributed components. The different units may be formed using different software and/or hardware combinations.

In example embodiments, the reading unit 282 may be executed by processor 242 of the computing device 240 to obtain data identifying the target appliance 210. For instance, the computing device 240 can include an image capture device 290 (e.g., camera) may be used to obtain an image of the target appliance 210. In example embodiments, the image includes the label 220. In alternative embodiments, the image includes the QR code 226, the bar code 228, or both.

In example embodiments, the computing device 240 can communicate with the electronic control board 120 to obtain data identifying the target appliance 210. More specifically, the computing device 240 can be configured to read data 126 stored in the memory device 124 of the control board 120. In this manner, the computing device 240 can obtain the model number 222 and the serial number 224 of the target appliance 210. In alternative embodiments, the computing device 240 can obtain data identifying the target appliance 210 from another electronic control board already installed on the target appliance 210.

In some embodiments, data 126 stored within the memory device 124 of the electronic control board 120 includes hardware configuration data. As such, the hardware configuration detection unit 284 can use the data identifying the target appliance 210 to determine whether the hardware configuration data stored within the memory device 124 of the electronic control board 120 is valid (e.g., correct). More specifically, the hardware configuration detection unit 284 can be configured to compare the hardware configuration data against reference data included in a lookup-table that can be stored on the computing device 240 or the server 270. For instance, the lookup-table can include a list of one or more appliances, such as the first and second appliances 100, 110 discussed above with reference to FIG. 1. The list can further include the most recent version of hardware configuration data for each of the one or more appliances. In this manner, the hardware configuration detection unit 284 can determine whether the hardware configuration data stored on the electronic control board 120 is valid.

In some embodiments, data 126 stored within the memory device 124 of the electronic control board 120 does not include hardware configuration data. In such embodiments, the hardware configuration detection unit 284 can compare the data identifying the target appliance 210 against the reference data included in the lookup-table to determine whether the target appliance 210 corresponds to at least one of the appliances included in the reference data. In this manner, the hardware configuration detection unit 284 can determine whether hardware configuration data exists for the target appliance 210.

When the hardware configuration detection unit 284 determines hardware configuration data exists for the electronic control board 120, the hardware configuration management unit 286 of the configuration controller 280 can generate a control action associated with writing the hardware configuration data into the memory device 124 of the electronic control board 120. More specifically, the control action can be a command to write the hardware configuration data into the memory device 124 of the electronic control board 120.

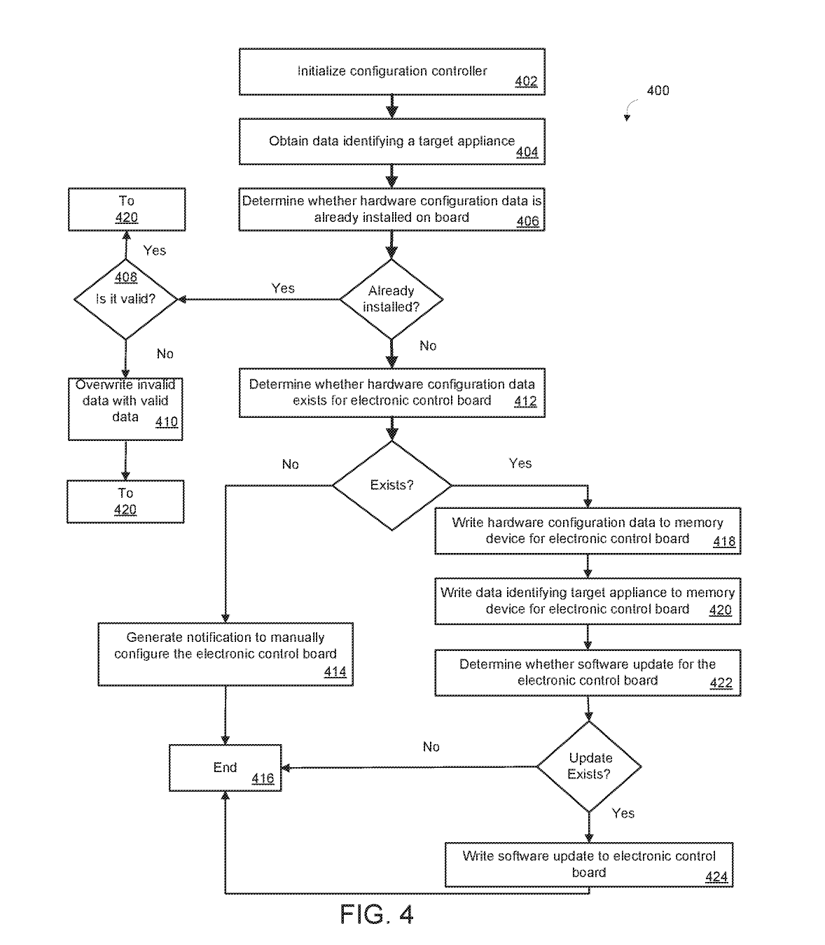

Referring now to FIG. 4, a flow diagram of a method 400 for configuring an electronic control board for a target appliance is provided according to example embodiments of the present disclosure. The method 400 can be implemented using, for instance, the configuration controller 280 discussed above with reference to FIGS. 2 and 3. FIG. 4 depicts steps performed in a particular order for purposes of illustration and discussion. Those of ordinary skill in the art, using the disclosures provided herein, will understand that various steps of the method 400 or any of the other methods disclosed herein may be adapted, modified, rearranged, performed simultaneously or modified in various ways without deviating from the scope of the present disclosure.

At (402), the method 400 includes initializing the configuration controller. In some implementations, initializing the configuration controller occurs each time the computing device is activated. The configuration controller may be initialized when powering-up the computing device, or in response to other events.

At (404), the method 400 includes obtaining, by one or more processors, data identifying a target appliance. In some embodiments, obtaining the data identifying the target appliance comprises obtaining, by the one or more processors, an image of the target appliance. More specifically, the image can depict at least one of a model number assigned to the target appliance and a serial number assigned to the appliance.

In alternative embodiments, obtaining data identifying the target appliance can include obtaining, by the one or more processors, input data from an input device. For instance, the input device can include a keypad associated with the computing device. In this manner, one or more keys on the keypad can be manipulated (e.g., pressed) to communicate the input data to the one or more processors. As an example, the input data can include, without limitation, at least one of the model number assigned to the target appliance and the serial number assigned to the target appliance.

At (406), the method 400 includes determining, by one or more processors, whether hardware configuration data is already installed on the electronic control board. More specifically, one or more processors can obtain data stored on the memory device of the electronic control board and inspect the data to determine whether the data includes hardware configuration data. If the data includes hardware configuration data, the method proceeds to (408). Otherwise, the method proceeds to (412).

At (408), the method 400 includes determining, by one or more processors, whether hardware configuration data stored in the memory device on the electronic control board is valid (e.g., correct). More specifically, data obtained at (404) that identifies the target appliance can be used to determine whether the hardware configuration data stored within the memory device of the electronic control board is valid (e.g., correct). More specifically, the data identifying the target appliance can be compared against reference data included in a lookup-table stored on the computing device or the server. For instance, the lookup-table can include a list of one or more appliances and associated hardware configuration data for each of the one or more appliances. In this manner, the hardware configuration data stored within the memory device of the electronic control board can be compared against the reference data to determine whether the hardware configuration data is valid (e.g., correct). If the hardware configuration data stored on the memory device of the electronic board does not match the reference data, the one or more processors determine the hardware configuration data stored in the memory device is invalid hardware configuration data, and the method (400) proceeds to (410). Otherwise, the method 400 proceeds to (420) and the one or more processors write the data identifying the target appliance to the memory device on the electronic control board.

At (410), the method 400 includes generating one or more control actions associated with overwriting the invalid hardware configuration data with valid hardware configuration data. More specifically, one or more processors can issue a command to overwrite the hardware configuration data stored in the memory device with hardware configuration data that is included in the look-up table and represents valid hardware configuration data for the target appliance. Once the invalid hardware configuration data has been overwritten with valid hardware configuration data, the method proceeds to (420) and the one or more processors write the data identifying the target appliance to the memory device on the electronic control board.

At (412), the method 400 includes determining whether hardware configuration data exists for the electronic control board. More specifically, the hardware configuration detection unit can compare the data obtained at (404) against reference data for one or more known appliances. As discussed previously, the reference data can include a model number and serial number assigned to each of the one or more known appliances. In some embodiments, the reference data can be stored in the computing device. In this manner, the computing device can be configured to compare the data obtained at (404) against the reference data. In alternative embodiments, the reference data can be stored in the server. In this manner, the server can be configured to compare the data obtained at (404) against the reference data.

In example embodiments, hardware configuration data exists when the data identifying the target appliance corresponds to one of the known appliances included in the reference data. For instance, hardware configuration data may exist for the electronic control board when the model number assigned to the target appliance matches a model number assigned to one or more of the known appliances. As will be discussed below in more detail, the method 400 proceeds to (414) when no hardware configuration data exists for the electronic control board. Otherwise, the method 400 proceeds to (418).

At (414), the method 400 includes generating, by the one or more processors, a notification (e.g., error message) indicating that no hardware configuration data exists for the electronic control board 120. In this manner, the notification can prompt a user (e.g., a technician) to manually configure the electronic control board. Once the notification is generated, the method 400 proceeds to (416) and ends. Alternatively, the method 400 can proceed to a block that has already been discussed. For example, the method 400 can proceed to block 404 and obtain additional data identifying the target appliance.

At (418), the method 400 includes writing the hardware configuration data to the memory device of the electronic control board. More specifically, the hardware configuration management unit of the configuration controller may be used to write the hardware configuration data to the memory device. In example embodiments, writing the hardware configuration data to the electronic control board includes issuing a command to the processor on the electronic control board. In particular, the command prompts the processor on the electronic control board to write the hardware configuration data to the memory device. Alternatively, the hardware configuration management unit of the configuration controller can be configured to write the hardware configuration data directly into the memory device. Once the hardware configuration data has been stored on the memory device, the method 400 proceeds to (420).

At (420), the method 400 can include writing data identifying the target appliance into the memory device of the electronic control board. More specifically, one or more processors can issue a command to write at least one of the model number and the serial number to the memory device of the electronic control board. Once the data identifying the target appliance is stored in the memory device, the method 400 proceeds to (422)

At (422), the method 400 includes determining whether one or more software updates exists for the electronic control board. For example, the computing device can issue a command to the server to check for software updates. Alternatively, the computing device can be configured to check for software updates. If one or more software updates exist for the electronic control board, the method 400 proceeds to (424). Otherwise, the method 400 proceeds to (416).

At (424), the method 400 includes generating one or more control actions associating with writing the one or more software updates to the electronic control board. For example, one or more processors can issue a command to write the one or more software updates to the memory device of the electronic control board.

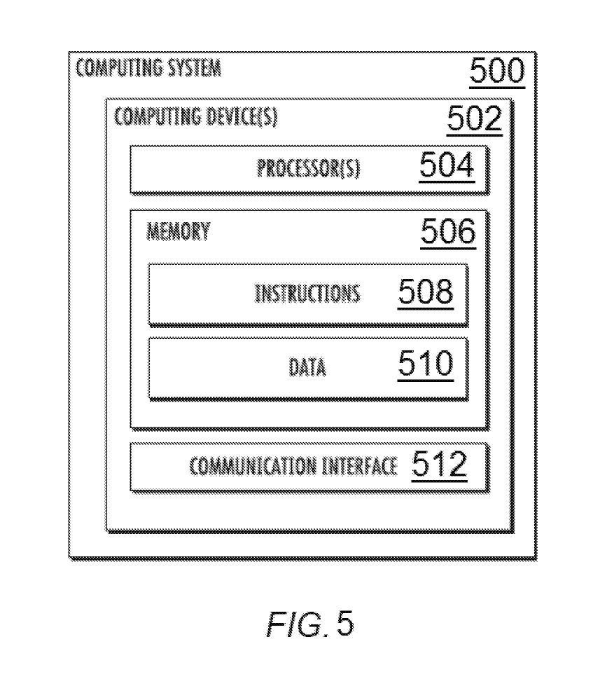

FIG. 5 depicts a block diagram of an example computing system 500 that may be used to implement methods and systems according to example embodiments of the present disclosure. As shown, the computing system 500 may include one or more computing device(s) 502. The one or more computing device(s) 502 may include one or more processor(s) 504 and one or more memory device(s) 506. The one or more processor(s) 504 may include any suitable processing device, such as a microprocessor, microcontroller, integrated circuit, logic device, or other suitable processing device. The one or more memory device(s) 506 may include one or more computer-readable media, including, but not limited to, non-transitory computer-readable media, RAM, ROM, hard drives, flash drives, or other memory devices.

The one or more memory device(s) 506 may store information accessible by the one or more processor(s) 504, including computer-readable instructions 508 that may be executed by the one or more processor(s) 504. The instructions 508 may be any set of instructions that when executed by the one or more processor(s) 504, cause the one or more processor(s) 504 to perform operations. The instructions 508 may be software written in any suitable programming language or may be implemented in hardware. In some embodiments, the instructions 508 may be executed by the one or more processor(s) 504 to cause the one or more processor(s) 504 to perform operations, such as implementing one or more of the processes mentioned above.

The memory device(s) 504 may further store data 510 that may be accessed by the processor(s) 504. For example, the data 510 can include the model number and serial number of a target appliance, as described herein. The data 510 may include one or more table(s), function(s), algorithm(s), model(s), equation(s), etc. according to example embodiments of the present disclosure.

The one or more computing device(s) 502 may also include a communication interface 512 used to communicate, for example, with the other components of system. The communication interface 512 may include any suitable components for interfacing with one or more network(s), including for example, transmitters, receivers, ports, controllers, antennas, or other suitable components.

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein may be implemented using a single computing device or multiple computing devices working in combination. Databases, memory, instructions, and applications may be implemented on a single system or distributed across multiple systems. Distributed components may operate sequentially or in parallel.

Although specific features of various embodiments may be shown in some drawings and not in others, this is for convenience only. In accordance with the principles of the present disclosure, any feature of a drawing may be referenced and/or claimed in combination with any feature of any other drawing.

This written description uses examples to disclose the claimed subject matter, including the best mode, and also to enable any person skilled in the art to practice the claimed subject matter, including making and using any devices or systems and performing any incorporated methods. The patentable scope of the disclosed technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claim.

What is claimed is:

1. A method for configuring an electronic control board for a target appliance, comprising:
obtaining, by one or more processors, data identifying the target appliance;
determining, by the one or more processors, whether hardware configuration data exists for the electronic control board based, at least in part, on the data identifying the target appliance; and
responsive to determining hardware configuration data exists for the electronic control board, generating, by the one or more processors, a control action associated with writing the hardware configuration data to a memory device on the electronic control board.

2. The method of claim 1, wherein obtaining data identifying the target appliance comprises obtaining, by the one or more processors, data from the memory device on the electronic control board, and wherein the data is indicative of at least one of a model number and a serial number assigned to the target appliance.

3. The method of claim 1, wherein obtaining data identifying the target appliance comprises obtaining, by the one or more processors, data from a memory device on another electronic control board installed on the target appliance, and wherein the data is indicative of at least one of a model number and a serial number assigned to the target appliance.

4. The method of claim 1, wherein obtaining the data identifying the target appliance comprises obtaining, by the one or more processors, an image of the target appliance.

5. The method of claim 4, wherein determining hardware configuration data comprises determining, by the one or more processors, hardware configuration data based, at least in part, on the image.

6. The method of claim 4, wherein the image of the target appliance depicts at least one of a model number and a serial number.

7. The method of claim 6, wherein determining the hardware configuration data comprises determining, by the one or more processors, the hardware configuration data based on at least one of the model and serial numbers.

8. The method of claim 1, wherein obtaining data identifying the target appliance comprises obtaining, by the one or more processors, input data via an input device, the input data indicative of at least one of a model number and a serial number assigned to the target appliance.

9. The method of claim 1, wherein obtaining data identifying the target appliance comprises obtaining, by the one or more processors, the data identifying the target appliance from at least one of a bar code and a quick response (QR) code.

10. The method of claim 8, wherein data identifying the target appliance identifies at least one of a model number assigned to the target appliance and a serial number assigned to the target appliance.

11. The method of claim 1, further comprising:
determining, by the one or more processors, whether one or more software updates exist for the electronic control board; and
responsive to determining one or more software updates exist for the electronic control board, generating, by the one or more processors, one or more control actions associated with writing the one or more software updates to the memory device of the electronic control board.

12. The method of claim 1, further comprising generating, by one or more processors, a control action associated with writing the data identifying the target appliance to the memory device, the data identifying the target appliance comprising at least one of a model number and a serial number both assigned to the target appliance.

13. The method of claim 1, further comprising:
responsive to determining no hardware configuration data exists for the target appliance, generating, by the one or more processors, a notification to manually configure the electronic control board.

14. A system for configuring an electronic control board for a target appliance, comprising:
one or more processors; and
one or more memory devices, the one or more memory devices storing computer-readable instructions that, when executed by the one or more processors, cause the one or more processors to perform operations, the operations comprising:
obtaining data identifying the target appliance;
determining whether hardware configuration data exists for the electronic control board based, at least in part, on the data identifying the target appliance; and
responsive to determining hardware configuration data exists for the electronic control board, generating a control action associated with writing the hardware configuration data to a memory device on the electronic control board.

15. The system of claim 14, wherein obtaining data identifying the target appliance comprises obtaining, by the one or more processors, data from the memory device on the electronic control board, the data indicative of at least one of a model number and a serial number assigned to the target appliance.

16. The system of claim 14, wherein determining hardware configuration data comprises determining, by the one or more processors, hardware configuration data based, at least in part, on the image.

17. The system of claim 16, wherein the image of the target appliance depicts at least one of a model number and a serial number.

18. The system of claim 17, wherein determining the hardware configuration data comprises determining, by the one or more processors, the hardware configuration data based on at least one of the model and serial numbers.

19. A method for configuring an electronic control board for a target appliance, the method comprising:
obtaining, by one or more processors, data identifying the target appliance;
determining, by one or more processors, whether hardware configuration data is stored in a memory device on the electronic control board;
responsive to determining no hardware configuration data is stored in the memory device, determining, by the one or more processors, whether hardware configuration data exists for the electronic control board based, at least in part, on the data identifying the target appliance; and
responsive to determining hardware configuration data exists for the electronic control board, generating, by the one or more processors, a control action associated with writing the hardware configuration data to a memory device on the electronic control board.

20. The method of claim 19, further comprising:
responsive to determining hardware configuration data is stored in the memory device, determining, by the one or more processors, whether hardware configuration data is valid hardware configuration data or invalid hardware configuration data; and
responsive to determining the hardware configuration data is invalid hardware configuration data, generating, by the one or more processors, a control action associated with overwriting invalid hardware configuration data with valid hardware configuration data.
